(19) United States
(12) Patent Application Publication
(10) Pub. No.: US 2020/0402173 A1
(43) Pub. Date: Dec. 24, 2020

(54) INVESTMENT SYSTEM

(71) Applicant: John R. Feloni, Somerville, MA (US)

(72) Inventor: John R. Feloni, Somerville, MA (US)

(21) Appl. No.: 17/010,384

(22) Filed: Sep. 2, 2020

Related U.S. Application Data
(63) Continuation of application No. 16/354,662, filed on Mar. 15, 2019.
(60) Provisional application No. 62/643,603, filed on Mar. 15, 2018.

(51) Int. Cl. G06Q 40/04; G06Q 20/10

(52) U.S. Cl. CPC G06Q 40/04; G06Q 20/10

(57) ABSTRACT

Described herein are embodiments of an investment system that acquires securities on behalf of a person based on information regarding commercial activity in which a person may engage. In some embodiments, the investment system may acquire securities on behalf of a purchaser based on information describing purchases made by the purchaser. In other embodiments, the investment system may electronically receive information regarding one or more commercial activities in which a person engages. Such commercial activities in which the person may engage may include visiting a store with or without making a purchase at the store, visiting a commercial website at which goods or services may be purchased with or without making a purchase via the website, posting on a website or a social network information related to a commercial organization, other activities in which the person interacts with a commercial organization or goods/services offered by a commercial organization.

### CROSS-REFERENCE TO RELATED APPLICATIONS

The present application claims priority under 35 U.S.C. 119(e) to U.S. Provisional Patent Application No. 62/643,603, filed Mar. 15, 2018, and titled “INVESTMENT SYSTEM,” the entire disclosure of which is hereby incorporated herein by reference.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an example of an investment system that may be implemented in some embodiments;

FIG. 2 illustrates an example of a process that may be carried out in some embodiments for acquiring securities on behalf of a purchaser; and

FIG. 3 illustrates one exemplary implementation of a computing device that may be used in a system implementing techniques described herein.

### DETAILED DESCRIPTION

Applicant has recognized and appreciated that access to stock ownership can be expanded and the investment process can be eased through tying investment to purchases made by purchasers from commercial organizations, such as retail businesses. More particularly. Applicant has recognized and appreciated the advantages of a computerized investment system that automatically makes investments on behalf of purchasers based on information regarding purchases made by those purchasers. In some embodiments, the investment system may execute on one or more computing devices and process information regarding purchases made by one or more purchasers. For example, such an investment system may receive purchase information identifying a purchase made by a purchaser from a commercial organization and determine, based at least in part on the purchase information, an amount of funds to invest on behalf of the purchaser. In particular, the investment system may determine an amount of funds to be used to purchase at least a fraction of a security on behalf of the consumer. The investment system may also select a security to purchase on behalf of the consumer, such as by selecting stock in the commercial organization from which the purchase was made in the case that the commercial organization is an entity for which stock is traded on a public exchange (i.e., a publicly-traded entity). The investment company may then receive from the purchaser the amount of funds to be used to purchase securities, acquire the securities, and store information in a data store of the investment system identifying that the securities are owned by the purchaser.

Applicant has recognized and appreciated that many people may be dissuaded from investing in securities like stocks because they do not have ready access to a large amount of funds to place into an investment account and/or feel they do not have the time or knowledge to decide where to invest their funds. Applicant has also recognized and appreciated that when people have an existing relationship with the commercial organizations from which they purchase goods and/or services, such existing relationships could form the basis of an investment strategy for these people. Applicant has further recognized and appreciated that businesses may benefit from a closer relationship with customers that would lead the customers to make more purchases from a business. Such a closer relationship between a business and its customers may be cultivated when the customers are owners of the business through owning stock in the business. Applicant has thus recognized that an investment system that assists a customer of a business in allocating funds and acquiring securities in the business based on, such as in response to, the customer making a purchase at that business can be beneficial to both customers and businesses. With such a system, the customers gain access to a simplified manner of stock purchasing and the businesses could gain the benefits of customers who are owners of the business and thus potentially more dedicated customers.

Accordingly, described herein are various embodiments of an investment system that acquires securities on behalf of a person based at least in part on information regarding commercial activity in which a person may engage. In some embodiments, including examples described below, the investment system may acquire securities on behalf of a purchaser based on information describes purchases made by the purchaser. Embodiments are not limited to acquiring securities based on information describing purchases or any other particular form of commercial activity, however. In other embodiments, the investment system may electronically receive information regarding one or more commercial activities in which a person engages. Such commercial activities in which the person may engage may include visiting a store with or without making a purchase at the store, visiting a commercial website at which goods or services may be purchased with or without making a purchase via the website, posting on a website or a social network information related to a commercial organization, other activities in which the person interacts with a commercial organization or goods/services offered by a commercial organization, or other activities in which the person distributes information regarding a commercial organization or goods/services of the commercial organization. The information that is electronically received by the investment system may be provided to the investment system by one or more computers related to the commercial organization, one or more computers that receive information describing the commercial activity, or one or more computers to which the person provides information as part of engaging in the commercial activity. Upon receipt of the information describing the commercial activity, the investment system may analyze the information and determine a manner in which to acquire securities based on the information describing the commercial activity.

Exemplary embodiments of such an investment system are described below. For ease of description, the commercial activity described in connection with these examples is making a purchase associated with a commercial organization. As should be appreciated from the foregoing, however, embodiments are not limited to operating with information describing a purchase and may additionally or alternatively operate with information describing other commercial activities.

Accordingly, in some embodiments, an investment system operating according to techniques described herein may be implemented on one or more computing devices and may automatically acquire securities for a purchaser based on information regarding the purchases. By automatically acquiring securities, the investment system may acquire securities based on information with which the system is configured, including one or more conditions for security acquisition with which the system is configured. Following detection that one or more conditions are met, such an investment system may acquire securities without human input or intervention to trigger the acquisition. Such an investment system operating on one or more computing devices may operate in any suitable manner to acquire securities, including receiving electronic notifications of purchases by a purchaser, electronically obtaining funds to be used in acquiring securities, and electronically negotiating the acquisition of securities via one or more brokerage services and/or directly with one or more sellers of securities. Such electronic communication may be carried out in any suitable manner, including via one or more computer communication networks, including private or direct point-to-point fiber optic networks, local area networks (LANs), wide-area networks (WANs), and/or the Internet.

As discussed in more detail below, in some embodiments, an investment system may operate on one or more servers able to send and receive information via a network, such as the Internet. The investment system may receive purchase information from another computing device of a commercial organization and/or a financial institution via the Internet. The investment system may then use the purchase information to identify a manner in which to acquire securities on behalf of the purchaser. The investment system may obtain funds for use in acquiring securities, such as through completing one or more electronic funds transfer (EFT) transactions via the Internet. Additionally, the investment system may negotiate the acquisition of securities via the Internet, such as through carrying out one or more known processes for electronically negotiating acquisition of securities, such as the purchase of stock on an exchange.

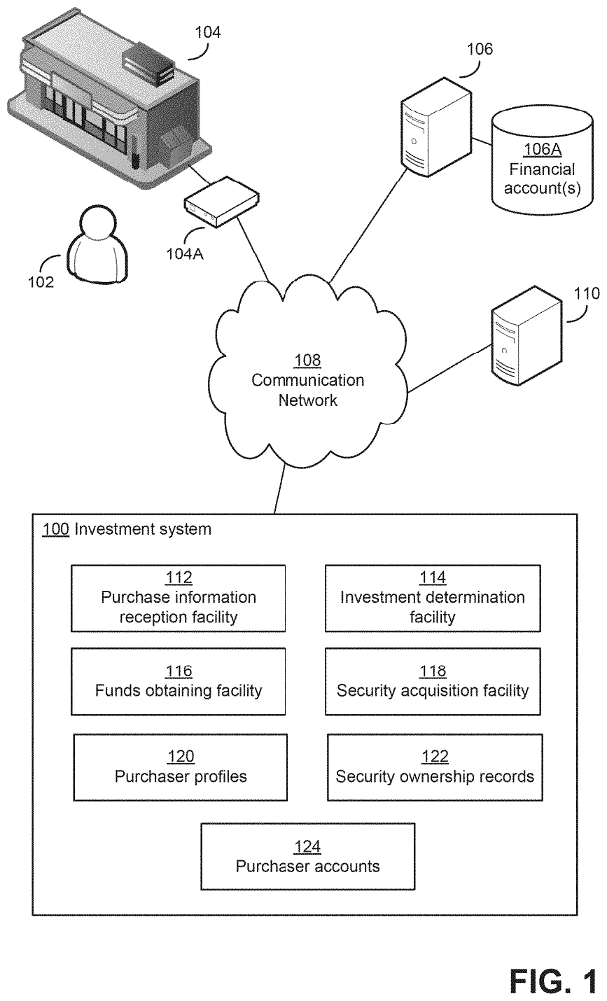

FIG. 1 illustrates an example of an investment system 100 that may be implemented in some embodiments in accordance with principles described herein. In the example of FIG. 1, an investment system 100 that operates to acquire whole and/or fractional share securities on behalf of one or more purchasers 102. The investment system 100 may be implemented as one or more software modules executing on one or more processors as well as data stored in one or more data stores of any suitable type. Illustrative facilities of the investment system 100, which may each include one or more software modules that are able to execute on one or more processors, are shown in FIG. 1. Examples of operations that may be carried out by these facilities are discussed below.

The investment system 100 acquires securities for a purchaser 102 in response to actions taken by the purchaser 102, including purchases made by the purchaser 102. As discussed in detail below, the investment system 100 may acquire the securities using funds obtained from the purchaser 102 and may acquire the securities in the name of the purchaser 102. Accordingly, each purchaser 102 for which the investment system 100 acquires securities may own the securities acquired by the investment system 100 for that purchaser 102.

Purchaser 102 is illustrated in FIG. 1 as a human purchaser. In the example of FIG. 1, the purchaser 102 may make one or more purchases from one or more commercial organizations 104. As discussed in detail below, a purchaser 102 may be any suitable entity (including natural and/or legal persons, or any other suitable entity) that can make a purchase and a commercial organization 104 may be any suitable entity from which a purchaser 102 may make a purchase. Commercial organization 104 is illustrated in FIG. 1 as a brick-and-mortar store, though it should be appreciated that investment system 100 is not limited to operating with commercial organizations that are brick-and-mortar stores.

When the purchaser 102 makes a purchase from a commercial organization, a computing device 104A, which may be a computing device or other computing device, of the commercial organization 104 may generate purchase information that describes the purchase made by the purchaser 102. The purchase information may include any suitable information describing the purchase. The purchase information may include, for example, information describing the purchaser 102, information describing the commercial organization 104, or information describing the terms of the transaction between the purchaser 102 and commercial organization 104. For example, the purchase information may identify the purchaser 102 (using, for example, a name and/or number related to the purchaser 102 and/or a financial account of the purchaser 102), identify the commercial organization 104, identify the goods and/or services purchased by the purchaser 102, and identify an amount of funds provided to commercial organization 104 in the purchase. The computing device 104A may be any suitable device that may generate information describing a purchase. For example, the computing device 104A may be a computing device that may be operated by a clerk during a purchase transaction, such as a cash register or card reader that reads financial account cards (e.g., credit cards or debit cards) with a magnetic, optical, RF, or other reader. As another example, the computing device 104A may be a web server or other computing device that may receive information regarding a purchase made from the commercial organization 104 and generate purchase information. Such a computing device may be, for example, a server executing an e-commerce service for selling goods over the World Wide Web. Embodiments are not limited to implementing any particular computing device 104A or any particular device to generate purchase information.

After the computing device 104A generates the purchase information, the computing device 104A may provide the purchase information to any suitable entity. In some embodiments, the computing device 104A may provide the purchase information to the investment system 100. In other embodiments, however, the computing device 104A may provide the purchase information to a financial institution or other entity involved in processing a purchase transaction (e.g., a processor, issuer, or bank associated with a credit or debit card), such as by providing the purchase information to a service operated by and/or for the financial institution and executing on one or more computing devices 106. The computing device 104A may provide the purchase information to the computing device(s) 106 in any suitable manner, such as by transmitting the purchase information over one or more communication networks 108. The communication network(s) 108 may be any suitable one or more wired and/or wireless networks, including local area networks (LANs) and/or the Internet.

For example, a purchaser 102 may make a purchase from the commercial organization using a credit card or other financial account. In this case, the computing device 104A may provide purchase information to a service of the financial institution associated with the financial account to request that the financial institution approve the purchase. The service, executing on the computing device(s) 106, may evaluate the purchase information and, if the purchase is approved, charge an account of the purchaser 102 for the value of the purchase indicated by the purchase information. The service may also store the purchase information. The purchase information may be stored by the service in either in the same form received from the computing device 104A or transformed in any suitable manner, as embodiments are not limited in this respect. The service may store the purchase information in, for example, a data store 106A of information regarding one or more financial accounts. For example, the service may store the purchase information in association with a financial account used by the purchaser 102 in making the purchase.

In some embodiments, as discussed below, the service executing on the computing device(s) 106 may provide the purchase information stored in the data store 106A to the investment system 100. In other embodiments, however, as discussed below, a financial reporting service executing on one or more computing devices 110 may communicate with the financial institution's service executing on the computing device(s) 106 to retrieve information regarding one or more financial accounts. The information regarding the financial accounts may include purchase information for purchases made using the financial accounts. Accordingly, in some embodiments, a financial reporting device of the computing device(s) 110 may communicate with the financial institution's service of the computing device(s) 106 to receive, over the network(s) 108, purchase information regarding purchases made by one or more purchasers 102.

Once the financial reporting service of the computing device(s) 110 has received the purchase information, the financial reporting service may provide the purchase information to the investment system 100. After receiving purchase information for a purchaser 102, the investment system 100 may evaluate the purchase information, determine a manner in which to acquire securities based on the purchase information on behalf of the purchaser 102, and acquire the securities. The investment system 100 may include one or more facilities to carry out operations of the investment system 100. As illustrated in FIG. 1, the investment system 100 may include a purchase information reception facility 112, an investment determination facility 114, a funds obtaining facility 116, and a security acquisition facility 118. Exemplary operations of these facilities are discussed in detail below.

The investment system 100 may also include data stores storing data that may be evaluated by the investment system 100 and/or the facilities of the investment system 100 as part of acquiring securities on behalf of one or more purchasers. For example, the investment system 100 may include a data store 120 of one or more profiles for one or more purchasers 102. A profile 120 may include information regarding one or more options that may be set by a purchaser 102 regarding a manner in which the investment system 100 is to evaluate purchase information and acquire securities on behalf of the purchaser 102. Examples of options that may be set by a purchaser 102 are discussed in detail below. The investment system 100 may also include a data store 122 of ownership records for securities. The ownership records 122 may reflect which securities that have been acquired by the investment system 100 are owned by which purchasers. The ownership records 122 may be used, for example, to track ownership in a case that public records of ownership of securities indicates that the investment system 100 or an entity that owns and/or operates the investment system 100 owns the securities. In this case, by maintaining the ownership records 122, the investment system 100 may be able to provide the benefit of ownership of individual securities or fractions of securities to the purchasers on whose behalf the securities were acquired, such as proceeds from sales, dividends, or other benefits. In other cases, though, the ownership records 122 may be stored even when public records indicate that the individual securities or fractions of securities are owned by the individual purchasers.

As illustrated in FIG. 1, the investment system 100 may also include a data store 124 of purchaser accounts. The purchaser accounts 124 may be financial accounts maintained by the investment system 100 for holding funds for acquiring securities on behalf of purchasers. In some embodiments, each purchaser 102 may have a purchaser account 122 with the investment system 100. Each purchaser 102 may deposit funds into the purchaser account 122, such as by electronically transferring funds from financial account maintained external to the investment system 100, such as a bank account of the purchaser or a credit card account of the purchaser, to the purchaser account 122. The deposit may be made in any suitable manner, such as through using an EFT transaction to deposit the funds in the purchaser account 122. In some embodiments, the funds in a purchaser account 122 may be obtained solely from the purchaser 102 associated with the purchaser account 122 or from sales by the investment system 100 of securities managed by the investment system 100 on behalf of the purchaser 102. In other embodiments, however, one or more other entities may additionally or alternatively deposit funds in the purchaser account 122 for use by the investment system 100 in acquiring securities on behalf of a purchaser 102.

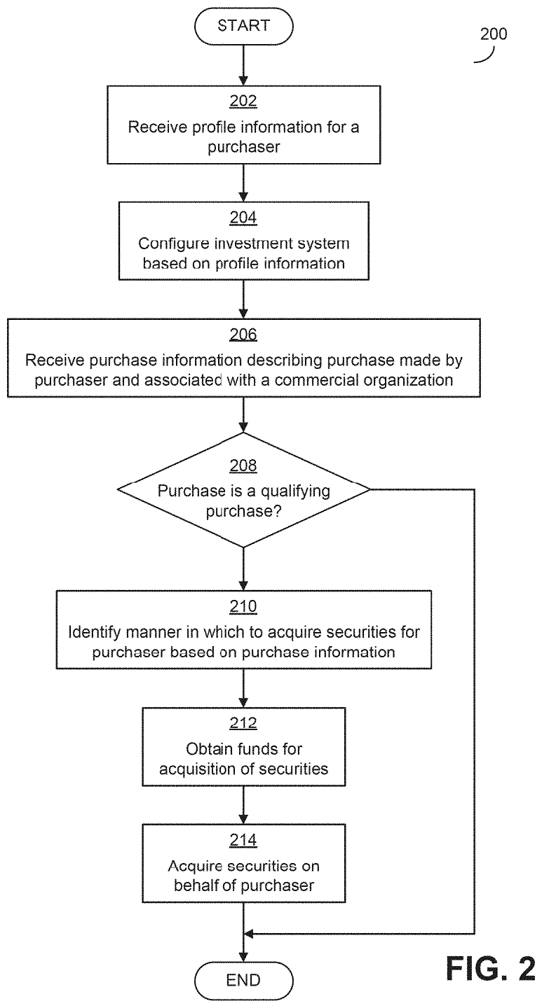

An investment system operating in accordance with techniques described herein may acquire securities in any suitable manner. FIG. 2 illustrates an example of a process that may be carried out in some embodiments for acquiring securities on behalf of a purchaser 102. In the example of FIG. 2, an investment system may operate on one or more computing devices to automatically acquire securities in accordance with options set for multiple purchasers and based on purchase information describing purchasers made by each purchaser. Prior to the start of the process 200, the investment system may be loaded onto one or more computing devices and configured to communicate electronically over one or more communication networks to acquire securities. For example, the investment system may be configured to electronically communicate with one or more brokerage services and/or one or more exchanges to purchase whole and/or fractions of securities on behalf of purchasers. The investment system may also be configured to electronically communicate with one or more financial institutions and/or financial reporting services to obtain funds and/or receive purchase information. The investment system may be configured, for example, to communicate with multiple financial institutions and may subsequently communicate with a particular financial institution with which the purchaser has an account to obtain funds and/or purchase information to be used in acquiring securities for the purchaser. The process 200 illustrates a process by which the investment system, once configured, may acquire securities on behalf of a purchaser.

The process 200 begins in block 202, in which the investment system receives profile information for a purchaser. The profile information may include any suitable information about the purchaser and/or a manner in which to acquire securities on behalf of the purchaser. The profile information may include, for example, information identifying the purchaser, such as name and address information, or any suitable information that a jurisdiction may require an investment system to have to acquire securities on behalf of a person. Profile information regarding a purchaser may also, in some embodiments, include information regarding one or more financial accounts associated with the purchaser. The financial accounts may include financial accounts held by external financial institutions for the purchaser and from which the investment system is to obtain funds to be used in acquiring securities, such as bank accounts of the purchaser. The financial accounts may also include financial accounts that the purchaser may use in making purchases, such as one or more credit and/or debit accounts of the purchaser maintained by one or more financial institutions. The investment system may be informed of the financial accounts that the purchaser may use to make purchases such that the investment system may monitor the financial accounts and request purchase information associated with the financial accounts.

The profile information may also include, for example, information regarding one or more configurable options to configure a manner in which the investment system acquires securities based on purchase information. Examples of configurable options are discussed below. In some cases, the configurable options may include, for example, options regarding types of securities that the investment system is to acquire based on purchase information and an amount of funds that the investment system is to use to acquire securities based on purchase information. As discussed below, the configurable options may be one set of configurable options to be evaluated by the investment system for all purchases made by a purchaser. Alternatively, the configurable options may be multiple sets of configurable options, each corresponding to a suitable grouping of purchase information. For example, in some embodiments, the profile information received in block 202 may include a set of configurable options for each of multiple commercial organizations and a set of default configurable options. In these embodiments, when the investment system subsequently receives purchase information, the investment system may determine whether the purchase information identifies a commercial organization for which a particular set of configurable options was received in block 202. If there is a particular set of configurable options corresponding to the commercial organization, the investment system may then evaluate the purchase information in accordance with the corresponding set of configurable options. Any suitable profile information may be received in block 202, as embodiments are not limited in this respect.

In block 204, the investment system configures itself with the profile information received in block 202. The investment system may configure itself with the profile information in any suitable manner. For example, the investment system may store the profile information such that the profile information may be subsequently retrieved when securities are to be acquired on behalf of a purchaser in response to receipt of purchase information. In a case that the profile information includes information on one or more financial accounts of the purchaser, the investment system may configure itself to communicate with financial institutions that hold the financial accounts. For example, the investment system may configure itself to carry out EFT transactions with a financial institution to request funds from a purchaser's financial account that are to be used in acquiring securities. Additionally, when the profile information includes information regarding a financial account that the purchaser may use to make purchases, the investment system may configure itself to receive purchase information regarding purchases made by the purchaser using the financial account. The investment system may configure itself to receive the purchase information in any suitable manner. In some embodiments, for example, the investment system may request that the financial institution that holds the financial account periodically or from time to time provide to the investment service purchase information regarding purchases made by the purchaser using the financial account. As another example, in some embodiments, the investment system may communicate with a financial reporting service and request that the financial reporting service monitor the financial account and periodically or from time to time provide the investment service with purchase information regarding purchasers made by the purchaser using the financial account.

After the investment system is configured to receive purchase information, in block 206 the investment system receives purchase information describing a purchase made by the purchaser that is associated with a commercial organization. The purchase may be associated with a commercial organization in any suitable manner. In some embodiments, for example, the purchase may be associated with a commercial organization when purchased goods or services are created and/or sold by the commercial organization. For example, in the case of goods, goods may be associated with a commercial organization when the commercial organization manufacturers the goods or contracts to have the goods manufactured. As another example, in the case of goods, goods may be associated with a commercial organization that sells the goods wholesale and/or retail. As another example, goods may be associated with a commercial organization when the goods are branded with a name or trademark of the commercial organization. Accordingly, in some embodiments, a purchase may be associated with a commercial organization when the purchase includes a purchase of goods branded by, manufactured by or for, and/or sold wholesale or retail by the commercial organization. In the case of purchases that include goods or services associated with multiple commercial organizations, such as a purchase that involves multiple goods that are each branded by a different commercial organizations, a purchase may be associated with any one, some, or all of the commercial organizations. For example, the purchase may be determined to be associated with the commercial organization from which the purchase was made. As another example, the purchase may be determined to be associated with one or more commercial organizations based on the values of goods included in the purchase. In the case that the values of goods are used to determine the associated the, the purchase may be determined to be associated with a commercial organization with the highest value good or combination of goods included in the purchase, or the top three commercial organizations based on value of goods, or associated with any other one or more organizations.

The investment system may receive the purchase information in block 206 in any suitable manner, including by receiving electronic messages via one or more communication networks from a computing device of the commercial organization, a computing device of a financial institution, and/or a computing device of a financial reporting service. Examples of ways in which the investment system may receive purchase information are described in detail below.

In some embodiments, all purchase information that is received by the investment system may be evaluated to determine a manner in which to acquire securities based on the purchase information, and the investment system may acquire securities based on all received purchase information. In other embodiments, however, an investment system may acquire securities based on only some purchase information received by the investment system. In such embodiments, purchase information received by the investment system may be evaluated to determine whether the purchase information describes a qualifying purchase. A qualifying purchase is a purchase that meets one or more conditions. When the one or more conditions are met by a purchase and is a qualifying purchase, the purchase qualifies for the investment system to acquire securities based on the purchase information describing the purchase and the investment system may therefore evaluate the purchase information to identify a manner in which to acquire securities based on the purchase information.

In block 208, the purchase information is evaluated to determine whether the purchase information describes a qualifying purchase. The investment system may evaluate the purchase information in any suitable manner in block 208, including by comparing the purchase information to any suitable one or more conditions to determine if the one or more conditions are met by the purchase information. Any suitable conditions may be evaluated, as embodiments are not limited in this respect.

In some embodiments, for example, a condition may relate to a commercial organization associated with the purchase. In some embodiments, an investment system may only acquire securities on behalf of a purchaser based on purchase information describing purchases associated with a particular set of one or more commercial organizations. In some such embodiments, the investment system may maintain one such set of commercial organizations that is evaluated for purchase information for all purchasers, while in other embodiments the investment system may maintain such a set of commercial organizations for each purchaser and evaluate the set associated with a purchaser for purchase information for that purchaser. Accordingly, in some embodiments, the purchase information may be evaluated in block 208 to determine whether the purchase information describes a purchase associated with one or more particular commercial organizations.

In some embodiments, a condition may relate to a purchase history of the purchaser. For example, in some embodiments, an investment system may acquire securities based on a limited amount of purchases associated with a commercial organization in a time period. For example, the investment system may acquire securities based on a set number of purchases, such as five purchases, or a set total value of purchases, such as the first $100 in purchases, associated with a commercial organization in a time period. The time period may be any suitable time period, as embodiments are not limited in this respect. In some embodiments, the time period may be a week or month or year. Accordingly, in some embodiments, a purchase history of the purchaser in a time period may be evaluated to determine an amount of purchases made by the purchaser that are associated with a commercial organization. In block 208, in these embodiments, the purchase information received in block 206 may be evaluated together with the purchase history to determine whether the purchase information and the purchase history does not exceed the limited amount of purchases associated with the commercial organization in a time period.

In some embodiments, a condition may relate to a current price of a security related to a commercial organization with which the purchase is associated. For example, in some embodiments, an investment system may be configured with a maximum price for a single security or share of a security. If the price of a security that is to be acquired based on purchase information exceeds that maximum price, the investment system may not acquire the security. In embodiments in which the investment system is configured with a maximum price, the investment system may be configured with one maximum price that the investment system evaluates for purchase information for all purchases, while in other embodiments the investment system may maintain maximum prices for each purchaser and evaluate different maximum prices for purchase information for different purchases. Accordingly, in some embodiments, in block 208, the investment system may determine a security related to a commercial organization associated with the purchase information, determine a current price of the security, and compare the current price to a maximum price.

In some embodiments, a condition may relate to a performance history of a security related to a commercial organization with which the purchase is associated. For example, a price of a security on an exchange may rise or fall over time. In some embodiments, the investment system may be configured to refrain from acquiring securities for which a performance history of the securities indicates that the securities may be a poor investment and/or may only acquire securities for which a performance history of the securities indicates a good investment. The investment system may evaluate a performance history according to any suitable one or more criteria to determine whether a performance history is indicative of a poor investment or of a good investment. As one example, if a performance history of a security indicates a falling price over a time period, the investment system may conclude that the performance history indicates that the securities are a poor investment, and the investment history may similarly conclude that a rising price over a time period indicates that the securities are a good investment. Accordingly, in block 208, in some embodiments, the investment system may determine a security related to a commercial organization associated with the purchase information, review a performance history of the security, and determine whether the security is a good investment or a poor investment.

In some embodiments, a condition may relate to a balance of securities in a purchaser's investment portfolio. Over time, an investment system may acquire securities related to commercial organizations that are associated with purchases made by a purchaser. If a purchaser makes more purchases that are associated with a first commercial organization than the examiner makes purchases that are associated with a second commercial organization, an investment portfolio for the purchaser may include more securities related to the first commercial organization than securities related to the second. Having a portfolio that has too many of one type of security and too little of another, or a portfolio that is weighted too heavily toward securities related to one company, may be risky in some circumstances. Accordingly, in some embodiments, the investment system may refrain from acquiring securities related to a commercial organization when a purchaser's portfolio includes more than a specified amount of securities. For example, when more than a specified percentage of securities of a purchaser's portfolio are securities related to one commercial organization, when the portfolio includes more than a specified whole number of securities related to a commercial organization, or when a combined value of securities, related to a commercial organization, in the portfolio exceeds a specified value, the investment system may refrain from acquiring more securities related to that commercial organization. In some embodiments, therefore, in block 208, the investment system may review a balance of the purchaser's portfolio to determine whether the investment system should acquire securities related to a commercial organization with which the purchase information is associated. Accordingly, in block 208, the investment system may evaluate the purchase information and/or any other information in any suitable manner to determine whether the purchase information describes a qualifying purchase. Embodiments are not limited to evaluating any particular condition or combination of conditions to determine whether purchase information describes a qualifying purchase.

If the purchase is determined in block 208 to be a qualifying purchase, in block 210, the investment system identifies a manner in which to acquire securities based on the purchase information received in block 206. The investment system may identify the manner in which to acquire securities in any suitable manner, including based on the profile information received in block 202 and based on the purchase information received in block 206. Identifying the manner in which to acquire securities may include, for example, identifying a security to acquire and an amount of funds to use in acquiring whole and/or fractional numbers of the security. Examples of ways in which the investment system may identify the manner in which to acquire securities are described in detail below.

In block 212, the investment system obtains funds to be used in acquiring the securities identified in block 210. The investment system may acquire an amount of funds determined in block 210. The investment system may obtain funds in any suitable manner. In some embodiments, the investment system may acquire funds from the purchaser, such that the purchaser's funds are used in acquiring securities on behalf of the purchaser. In some such embodiments, the purchaser's funds may be obtained from a purchaser account maintained by the investment system for a purchaser. The purchaser account maintained by the investment system may include funds that are deposited into the account by a purchaser, or that are withdrawn from another financial account of the purchaser (e.g., a bank account of the purchaser) by the investment system using one or more EFT transactions and deposited into the purchaser account. Examples of ways in which the investment system may obtain funds are described in detail below.

In block 214, the investment system acquires securities on behalf of the purchaser. The investment system may acquire the securities using any suitable securities acquisition technique, as embodiments are not limited in this respect. Securities may be acquired directly from a prior owner of the securities, through a public or private transaction, or may be acquired in a public exchange. The investment system may acquire the securities with or without using a broker or brokerage service, or any other intermediary. In some cases, as part of acquiring securities for the purchaser, the investment system may purchase securities from another entity on behalf of the purchaser. In other cases, however, as part of acquiring securities for the purchaser, the investment system may not carry out a new purchase of securities but may allocate to the purchaser securities owned by the investment system. For example, in some such cases, the investment system may acquire a security and hold that security on its own behalf (or on behalf of an operator of the investment system). Then, upon receiving purchase information and determining that the security is to be acquired on behalf of the purchaser, the investment system may allocate that security to the purchaser such that the purchaser owns the security.

Accordingly, different embodiments may carry out different electronic transactions as part of acquiring securities on behalf of purchasers. For example, in some embodiments, the investment system may electronically communicate with a brokerage service executed by one or more computing devices to request that securities be acquired. As another example, in some embodiments, the investment system may communicate with a market exchange service operated by a securities exchange and executed by one or more computing devices to request that securities be acquired. Embodiments are not limited to carrying out any particular electronic transaction or series of electronic transactions to acquire securities.

The investment system may acquire securities on behalf of the purchaser in any suitable manner, examples of which are described below. As discussed in detail below, the investment system may acquire securities at any suitable time and in any suitable amount, such as by acquiring securities in response to each receipt of purchase information or after one or more conditions have been met.

In some embodiments, in acquiring securities on behalf of the purchaser, the investment system may acquire the securities such that public ownership records regarding the securities indicate that the purchaser owns the securities. In other embodiments, the investment system may acquire the securities such that public ownership records indicate another entity owns the securities, which may be the investment system or an entity that owns and/or operates the investment system. In embodiments in which public ownership records do not indicate that the purchaser owns the acquired securities, the investment system may in block 214 store information in a data store of the investment system indicating that the purchaser owns the securities.

After the securities are acquired in block 214, or if the purchase is determined in block 208 not to be a qualifying purchase, the process 200 ends. As a result of the process 200, the investment system manages the acquired securities on behalf of the purchaser. In managing the securities, the investment system may provide benefits of ownership of the securities to the purchaser. For example, if a dividend is issued for the security, the investment system may provide the dividend to the purchaser, such as by depositing the dividend in the purchaser account for the purchaser. As another example, if the purchaser desires to sell the acquired securities, the investment system may sell the securities and provide funds resulting from the sale to the purchaser.

Various examples of ways in which investment systems may be implemented and illustrative facilities of investment systems may operate are discussed below. It should be appreciated, however, that embodiments are not limited to operating in accordance with any one or more of the examples described below. Embodiments may be implemented in any suitable manner.

Investment systems operating according to techniques described herein may acquire securities in any suitable manner. In some embodiments, the securities may be acquired for the purchaser such that the securities are owned by the purchaser and, in the case that public records are maintained regarding the acquired securities, the public records indicate that the purchaser owns the securities. In other embodiments, the securities may be acquired for the purchaser on behalf of the purchaser such that the investment system or an entity (e.g., a company) operating the investment system owns the securities and any applicable public records reflect ownership by the system or operating entity. However, in the case that the investment system or operating entity owns the securities, the investment system may store information indicating that the securities are held in the name of, held for the benefit of, owned by, held for the benefit of, and/or owned on behalf of the purchaser.

In some embodiments, the investment system may acquire at least a fraction of a security based at least on purchase information. A purchase information reception facility of the investment system may receive purchase information and trigger a process for acquiring at least a fraction of a security based on the purchase information. The purchase information may indicate a purchase made by a purchaser from a commercial organization. The purchase information may indicate any suitable information about the purchase, as embodiments are not limited in this respect. In some embodiments, the purchase information may include an amount of funds exchanged in the purchase before and/or after any sales or other taxes applied to the purchase, a date and/or time of the purchase, an identification of a good or service purchased, an identification of the purchaser, and/or an identification of the commercial organization.

The purchase information may be in any suitable format and be received by the purchase information reception facility of the investment system from any suitable source, as embodiments are not limited in this respect. In some embodiments, a purchaser may register a financial account with the investment system, where the financial account is maintained by a financial institution for the purchaser. Such a financial account may be a banking and/or credit account, such as a checking account or a revolving credit account associated with a credit card. When the purchaser uses the financial account in the purchase, such as by presenting a debit and/or credit card during the purchase, purchase information may be collected by the financial institution. The purchase information may then be provided by the financial institution to the investment system via a computer communication network (which may be or include a local area network or the Internet, or any other network or combination of networks), and received by the purchase information reception facility of the investment system. The financial institution may provide the purchase information for any suitable reason and/or in response to any suitable stimulus. For example, in some embodiments, the purchaser and/or the investment system may inform the financial institution that the financial account has been registered with the investment system and request that the financial institution provide (at that time, or in the future periodically or from time to time) purchase information for all purchases made by the purchaser, or for purchases meeting one or more specified criteria, to the investment system. As another example, in some embodiments, the investment system may periodically or from time to time request purchase information from the financial institution, such as once per day or per week. As another example, in some embodiments, a third party financial monitoring service may retrieve purchase data from a financial institution for a financial account and provide the purchase information to the purchase information reception facility of the investment system. Examples of third party financial monitoring services that may be used in embodiments include the YODLEE® service available from Yodlee, Inc., of Redwood City, Calif., or the TSYS® GOLDEN RETRIEVER SYSTEMS™ service available from TSYS Acquiring Solutions LLC of Tempe, Ariz.

It should be appreciated, however, that embodiments are not limited to receiving purchase information at the investment system from a financial institution. In some other embodiments, a purchaser may provide purchase information to the purchase information reception facility, such as by manually entering purchase information into a web site or other interface. In some other embodiments, the purchase information reception facility may receive purchase information from a commercial organization from which the purchase was made. For example, when the purchaser is a member of an incentive program with the commercial organization, such as a frequent shopper program or loyalty program, the commercial organization may store purchase information regarding purchases made by the purchaser. The commercial organization may then provide the purchase information to the investment system, with or without receiving a request for the purchase information from the investment system. As another example, the purchaser may, during a purchase transaction, present a card, code, or other identifying information indicating that the purchaser has an account with the investment system. In response, the commercial organization (such as a point of sale terminal or other computer system of the commercial organization) may transmit the purchase information to the investment system. In still other embodiments, the purchaser may use a mobile device to obtain the purchase information from the commercial organization during the purchase, such as by initiating, during the purchase or at any other suitable time, communication between the mobile device and a device operated by the commercial organization. Once the purchaser's mobile device receives the purchase information, the purchaser's mobile device may transmit the information to the investment system. In embodiments, investment systems operating in accordance with principles described herein may receive purchase information regarding purchases made by purchasers in any of various ways, as embodiments are not limited in this respect.

Based on the purchase information for a purchase made by a purchaser, an investment determination facility of the investment system may determine, based at least in part on an evaluation of the purchase information, a manner in which to acquire securities on behalf of the purchaser. Determining a manner in which to acquire securities may include determining one or more types of securities to acquire and/or an amount of funds to invest. The investment determination facility of the investment system may evaluate the purchase information in any suitable manner, including by evaluating an amount of funds exchanged in the purchase and a commercial organization from which the purchase was made.

The investment determination facility may determine one or more types of securities to acquire in any suitable manner. In some embodiments, in response to receiving purchase information regarding a purchase, the investment determination facility may identify one or more types of securities that are related to a commercial organization at which the purchase was made. A security may be related to the commercial organization when the security was created by or for the commercial organization. For example, where the commercial organization from which the purchase was made is a publicly-traded entity, the investment determination facility may identify one or more types of publicly-traded stock in the commercial organization as securities to be acquired. As another example, the investment determination facility may identify a bond or other debt security issued by the commercial organization as a security to acquire.

In the case that the commercial organization from which a purchase was made is not a publicly-traded entity or otherwise has no securities publicly available for purchase, the investment determination facility may determine related securities by identifying securities of other commercial organizations that have a business relationship with the commercial organization. A second commercial organization may have a business relationship with the commercial organization when it is a parent company, sibling company, or subsidiary company of the commercial organization. Additionally or alternatively, a second commercial organization may have a business relationship with the commercial organization when it is a competitor to the commercial organization or otherwise operates in a same industry as the commercial organization.

In some cases, an investment determination facility may be unable to identify a security that is related to the commercial organization from which the purchase was made. In some embodiments, when the investment determination facility is unable to determine a security that is related to the commercial organization, the investment system may refrain from acquiring securities in response to that purchase or may instead acquire securities unrelated to the commercial organization. In some embodiments in which the investment system acquires unrelated securities, the investment system may acquire securities related to one or more other commercial organizations from which the purchaser has made purchases. For example, an amount of funds that the investment system would otherwise have used to acquire securities related to the commercial organization may be used to acquire securities related to one or more other commercial organizations from which the purchaser has made purchases. In these embodiments, the amount of funds may be allocated to the purchase of these other securities in any suitable manner, such as by being allocated to all of the commercial organizations in proportion to a total amount of purchases made by the purchaser at each commercial organization. In other embodiments in which the investment determination facility of the investment system is unable to determine a security that is related to the commercial organization, the investment determination facility may identify one or more default securities, such as shares in a default mutual fund or default index fund, as securities to be acquired. The default may be a default for the investment system and/or a default of a purchaser for which securities are to be acquired. In cases in which the default is a default for the purchaser, information regarding the default securities may be stored in a profile maintained by the investment system for the purchaser. Profiles for purchasers and information that may be maintained in a profile are described in greater detail below.

In some embodiments, in addition to or as an alternative to identifying securities related to a commercial organization at which the purchase was made, the investment determination facility may identify securities related to a commercial organization that manufactures or distributes goods purchased by the purchaser. For example, the purchase information may, in some embodiments, identify particular goods purchased by the purchaser. These goods may have been manufactured and/or distributed by a commercial organization. In the case that a purchaser purchases shoes that are distributed by NIKE®, Inc., the purchase information may identify the shoes and the investment determination facility may identify that securities related to NIKE® are to be acquired. While in embodiments below, for ease of description, the commercial organizations to which securities relate is described as the commercial organization at which the purchase was made, it should be appreciated that embodiments are not limited in this way. Embodiments are not limited to determining securities to acquire in any particular manner.

As part of determining a manner in which to acquire securities based on purchase information, the investment determination facility may also determine an amount of funds to invest in securities. The facility may make this determination in any suitable manner. In some embodiments, the investment system may maintain a profile for a purchaser that includes options configured by the purchaser on a manner in which securities are to be acquired for the purchaser. The configurable options may include an indication of an amount of funds to be invested in securities in response to each purchase made by the purchaser. In some cases, the amount of funds to be invested may be proportional to an amount of funds exchanged in the purchase, such as one or three percent of the amount of funds exchanged in the purchase. In some such cases where the amount is proportional, the configurable option may include a maximum amount to be invested, such as one percent but not greater than ten dollars. In other cases the amount of funds to be invested may be a fixed amount, such as one dollar for each purchase.

In some embodiments, the configurable options may be one set of options for all commercial organizations from which the purchase may make purchases, and the investment determination facility may evaluate the one set of options when purchase information is received and securities are to be acquired. In other embodiments, however, the purchaser may configure the investment system with multiple sets of options, where each set of options may correspond to one or more commercial organizations and may correspond to different commercial organizations from other sets of options. For example, in some embodiments, the purchaser may configure a manner in which to acquire securities for each of multiple commercial organizations in which the consumer has made, may make, or will make purchases and for which securities may be acquired. For example, the purchaser may provide, for each commercial organization, an indication of an amount of funds that are to be invested in securities. The amount of funds for each commercial organization may specify an amount of funds that are to be used in acquiring securities related to the commercial organization following a purchase made by the purchaser at that commercial organization. The indication provided by the purchaser may be different for each commercial organization, such as a different proportional amount, different maximum, or different fixed amount for each commercial organization. In some such embodiments in which the purchaser may configure the manner in which to acquire securities for each commercial organization, the purchaser may set configuration options for only some commercial organizations at which the purchaser may make purchases and additionally configure a default option to be used for other organizations. As another example, rather than or in addition to sets of options that correspond to particular commercial organizations, the purchaser may configure the investment system with a set of options that corresponds to any suitable set of multiple commercial organizations. For example, the purchaser may configure a set of options for an industry, or sets of options that each correspond to an industry and the commercial organizations that operate in that industry. In embodiments in which multiple sets of configuration options are set by a purchaser, the multiple sets of configuration options may be stored in a profile for the purchaser. The investment determination facility of the investment system may evaluate a purchaser profile to identify which of the sets of configuration options should be used in determining a manner in which to acquire securities based on purchase information. The investment determination facility may therefore select, based on purchase information, a set of configuration options from the multiple sets and identify a manner in which to acquire securities based on the selected set.

The configuration options of a purchaser profile may include any suitable set of options relating to a manner in which to acquire securities, in addition to or as an alternative to the examples discussed above: a type of securities to acquire and an amount of funds to invest. For example, in some embodiments, the investment system may enable the purchaser to configure options regarding a maximum amount of funds to invest in the acquisition of securities in a week or in a month. Such a maximum amount may be a maximum for all securities related to all different commercial organizations, and/or may be a maximum amount to invest in securities related to a particular commercial organization. In some embodiments, the investment system may enable the purchaser to configure options regarding a minimum amount of funds that are to be accrued before the investment system acquires securities using the funds. The minimum amount may be configured for each commercial organization and identify a minimum amount of funds that are to accrue before the investment system acquires securities related to the commercial organization using the funds.

Once the investment system has determined a manner in which to acquire securities for the purchaser, which may include identifying an amount of funds to invest and securities to acquire, a funds obtaining facility of the investment system obtains funds for acquiring the securities. Obtaining the funds for acquiring the securities may include obtaining the funds from the purchaser, from the commercial organization, from a financial institution, from an operator of the investment system (i.e., an entity that owns or operates the investment system), or from any other suitable party. The funds that are obtained may be funds that are owned by the source of the funds or may be funds that are owned by another but managed on behalf of the source of the funds. For example, funds that are obtained from the purchaser may be obtained from a financial institution managing funds on behalf of the purchaser, where the financial institution has a contractual obligation to make the funds available to the purchaser (e.g., a bank holding funds for a purchaser). As another example, funds that are obtained from the purchaser may be obtained from an operator of the investment system, which may maintain an account for the purchaser from which funds may be withdrawn for the acquisition of securities by the investment system. The account maintained by the operator may be maintained by the operator solely, may be maintained by a financial institution on behalf of the operator, or may be maintained in any other suitable manner, as embodiments are not limited in this respect. In the case that the operator maintains an account for the purchaser, the purchaser may periodically or from time to time deposit funds into the account (or the investment system may withdraw funds from another financial account of the purchaser for deposit into the account) and the funds obtaining facility may obtain funds from that account in response to receipt of purchase information regarding a purchase made by the purchaser and use the funds to acquire securities.

The funds may be obtained in any suitable manner, as embodiments are not limited in this respect. In some embodiments, the investment system may request that the funds be transferred from an account holding the funds, such as an account maintained by an operator of the investment system or a financial account maintained by a financial institution. The request may be formatted in any suitable manner. In some embodiments, the investment system may transmit a withdrawal request to an entity managing funds on behalf of the purchaser, requesting that the funds be transferred and indicating the dollar amount to be transferred. The withdrawal request may be transmitted in any suitable manner. In some embodiments, the withdrawal request may be transmitted using a known computer-based protocol for exchanging funds between financial institutions, such as using an Electronic Funds Transfer (EFT) request.

In other embodiments, a request for funds transmitted by the funds obtaining facility may not include a dollar amount of funds to be transferred, but may instead include a percentage that indicates how to calculate amount of funds to invest as a proportion of the amount of funds exchanged in the purchase. For example, in some embodiments, a financial institution that acts as a credit issuer and manages a revolving credit account associated with a credit card held by the purchaser may store information indicating that the credit card has been associated with the investment system. As a result of the association, when the purchaser uses the credit card to make a purchase, the financial institution may add a supplemental amount to a value of at least some of the purchases made using the card and thereby charge the purchaser the supplemental amount. The supplemental amount may be an amount that is to be used by the investment system to acquire securities. The financial institution may, as with other credit transactions, provide the supplemental amount of funds to the investment system for use in acquiring securities and subsequently receive that amount of funds from the purchaser. To determine the supplemental amount, the financial institution may contact the investment system. Accordingly, in some embodiments, while clearing a credit transaction involving the credit card, a financial institution may transmit purchase information to the investment system. The transmission of purchase information may include a request for information regarding an amount of funds to be invested. The investment system may then determine the amount of funds to be invested based on the purchase information, as discussed above, and may respond to the financial institution with an indication of the amount of funds. The indication of the amount of funds may, in some embodiments, be a percentage value configured by the purchaser. The financial institution may add the supplemental amount of funds to the transaction or otherwise charge the purchaser's account for the supplemental amount of funds. The funds obtaining facility of the investment system may subsequently receive the funds from the financial institution in any suitable manner, such as through an EFT transaction.

In some embodiments, the funds obtaining facility may obtain funds in bulk periodically or from time to time, rather than obtaining an amount of funds based on a purchase following each purchase. The obtaining of funds in bulk may be carried out for a single purchaser, such as to obtain an amount of funds calculated based on purchase information for multiple purchases made by the purchaser. Additionally or alternatively, funds may be obtained in bulk for multiple purchasers, such as purchasers that all have accounts with a single financial institution, such that funds may be obtained from the financial institution for multiple purchasers at one time. Obtaining funds in bulk may be more efficient in some cases, as an amount of funds to be invested based on a purchase may be small in some cases, such as less than one dollar or less than five dollars. In some such embodiments, the investment system may track a total amount of funds to be obtained based on purchases made by a purchaser and track how those funds are to be allocated to the acquisition of securities. The investment system may, for example, track which funds are to be used to acquire securities related to which commercial organization which amounts of funds relate. Once one or more criteria are met, such as following a set period of time or after accrual of more than a threshold amount of funds to be invested in securities relating to a particular commercial organization, the investment system may obtain funds and acquire securities. The investment system may acquire securities on behalf of a purchaser before or after the funds are obtained, as embodiments are not limited in this respect.

The investment system may acquire securities on behalf of the purchaser, as discussed above, using an amount of funds to invest that is calculated based at least in part on the purchase information. In some embodiments, an entirety of an amount of funds to invest calculated based on the purchase information may be used to acquire securities, while in other embodiments the investment system may charge a transaction fee or other service fee for the transfer of funds and/or acquisition of securities.

A securities acquisition facility of the investment system may acquire the securities in any suitable amounts, including fractions of securities or whole securities, including fractions of shares in a security or who shares in a security, as embodiments are not limited in this respect. In some embodiments, the investment system may acquire fractions of securities responsive to a purchase made by a purchaser, and following close in time to determining an amount of funds to invest, regardless of the amount of funds to be invested based on that purchase. In other embodiments, however, the investment system may track an amount of funds to be invested for each type of security in which the investment system is to invest and the security acquisition facility may acquire fractional and/or whole securities of that type (including whole shares in a security) only after the amount of funds to be invested exceeds a threshold, such as a cost of one whole security of the type of security. Additionally or alternatively, in some embodiments (either those that operate with fractional securities or only whole securities), the security acquisition facility may acquire securities at set time intervals. For example, in some embodiments, the investment system may track purchases made by a consumer in a day, week, month, or other interval and the facility may acquire securities related to each of multiple commercial organizations at the end of the day, week, or month (or other suitable time interval). In some embodiments, the security acquisition facility may acquire securities once a combination of criteria are met, such as at set intervals (e.g., once per week) when an amount of accrued funds for a particular type of security is above a threshold.

The security acquisition facility may acquire securities on behalf of a purchaser in any suitable manner. In some embodiments, the security acquisition facility may acquire the securities such that the purchaser owns the securities. For example, in some jurisdictions, public records are maintained regarding ownership of some types of securities. In some embodiments, in such jurisdictions, when a type of security is acquired for which public records are maintained, the security acquisition facility may acquire the securities such that the public records indicate that the purchaser is the owner of the securities. In addition, in some such embodiments, the security acquisition facility may request that the public records be updated to reflect ownership by the purchaser.

In other embodiments, however, the security acquisition facility may acquire securities such that the securities are owned by the investment system and/or an operator of the investment system. In such embodiments, however, the security acquisition facility may store information indicating that the securities are owned by the purchaser on whose behalf the securities were purchased. Such information may be stored in records maintained by the investment system, such as electronic records stored in a storage accessible to one or more computing devices on which the investment system executes. In some embodiments in which the investment system and/or the operator of the investment system is the public owner of the securities, the security acquisition facility may store information indicating, however, that each of the individual securities (and/or fractions of securities) is owned by an individual purchaser. Additionally or alternatively, the security acquisition facility may store information indicating, for each purchaser, a percentage of a total value of a securities portfolio that is owned by the purchaser. The percentage of the total value owned by a purchaser may be based on which securities of the portfolio were acquired by the security acquisition facility based on purchase information for the purchaser and a value of the securities at a time.

The investment system may also receive instructions from purchasers to sell securities acquired on their behalf. If the securities were acquired by the investment system on behalf of the purchasers, following receipt of a sell instruction, the investment system may sell the securities in an exchange or other public or private securities market. Any proceeds from the sale of securities acquired on behalf of the purchasers may be provided to the purchasers, minus (in some embodiments) one or more fees for the sale transaction or other services provided by the investment system. The investment system may return proceeds from the sale to the purchaser in any suitable manner, including by transferring funds (e.g., using an EFT transaction) to a financial account of the purchaser maintained by a financial institution or transferring the funds to an account maintained for the purchaser by the investment system or an operator of the investment system.

In some embodiments, the investment system may acquire securities on behalf of a purchaser outside the context of purchases made by the purchaser. For example, in addition to acquiring securities for the purchaser in response to receiving purchase information regarding a purchase, the investment system may act as a broker for a purchaser or provide an interface to a brokerage system for the purchaser that is external to the investment system. When acting as a broker for a purchaser, a brokerage facility of the investment system may acquire securities based on an instruction from the purchaser to acquire securities and following receipt of funds from the purchaser for that acquisition. Additionally, the brokerage facility may sell securities in response to a sell instruction from the purchaser. When providing an interface to an external brokerage system, the investment system may provide the purchaser with information on how to contact the brokerage system, such as a web address or other identifying information that permits the purchaser to communicate directly with the brokerage system. Alternatively, a brokerage facility of the investment system may play an active role in exchanging communications between the purchaser and the brokerage system, such as by receiving a request for information from the brokerage system, prompting the purchaser to provide the information, and providing responses received from the purchaser to the brokerage system.

It should be appreciated that embodiments may operate with any suitable purchaser and any suitable commercial organization. A purchaser may be any suitable person who may make a purchase or on whose behalf a purchase may be made, such as a natural person like a human or a legal person (e.g., a business entity). A commercial organization may be any suitable organization, including a business entity such as a corporation or a sole proprietorship, that may engage in commerce and from which a person may make a purchase. In some cases, a commercial organization may be a publicly-traded entity such that stock in the commercial organization may be acquired through an open exchange. However, it should be appreciated that embodiments are not limited to operating with securities that are common stock and are not limited to operating with commercial organizations that are publicly-traded entities.

As a specific example of a way in which an investment system may operate in some embodiments, a human consumer may purchase goods from a retail business for which stock is publicly traded in an exchange. The consumer may use a credit card to make the purchase, which results in the credit card issuer maintaining purchase information regarding the purchase in an account for the consumer. A financial monitoring service, such as the YODLEE® service mentioned above, may retrieve the purchase information and provide the purchase information to the investment system. Upon receiving the purchase information, the investment system may determine from a profile maintained for the consumer an amount of the consumer's funds to invest in stock in the retail business. The consumer's profile may indicate that a percentage of the funds exchanged in the purchase transaction are to be used for the purchase of stock, and the investment system may therefore calculate an amount of funds to invest back on the percentage and the amount indicated by the purchase information.

In this particular embodiment, the consumer may maintain an account with the investment system in which the consumer periodically deposits funds (or into which the investment system periodically deposits funds following making a withdrawal from a financial account of the consumer) for subsequent use in acquiring stock. After the investment system determines the amount to invest, the amount is compared to the current price of the stock in the exchange. If the amount, together with any amounts previously determined from prior purchases made from the retail business by the consumer, exceeds the current price of the stock in the exchange, the investment system acquires the most whole shares the system is capable of acquiring with the amount of funds available for acquisition of shares of the retail business for the consumer. The investment system may then update public records to indicate that the investment system or an operator of the investment system owns the stock, but store information in records of the investment system indicating that the consumer owns the stock. The investment system may then inform the consumer that the consumer owns the stock. As a result of the stock acquisition, the consumer may consider him- or herself a stock holder in the retail business, which may strengthen the consumer's relationship with the retail business and result in the consumer shopping at the retail business more often. At some later time, potentially following an increase in the price of the stock, the consumer may instruct the investment system to sell the stock. Following receipt of the sell instruction, the investment system may sell the stock in the exchange and provide at least part of the proceeds of the sale to the consumer.

In some embodiments, the investment system may also include or may interoperate with one or more social networks. In some embodiments in which the investment system includes a social network facility, the social network facility may permit purchasers that have accounts with the investment system to connect with other purchasers by viewing profiles other purchasers and/or exchanging messages with the other purchasers. The social network facility may display any suitable information in a social networking profile of a purchaser, including information describing an identity of the purchaser and information describing investments of the purchaser. Investment information may include information regarding which organizations the purchaser has invested in, such as a list of all organizations for which the purchaser owns securities or the top organizations by dollar amount or by number of securities for which the purchaser owns securities. The social network facility of the investment system may, in some embodiments, enable a purchaser to announce to other purchasers or other users of the social network when the purchaser has reached certain milestones in investment, such as by acquiring a new security, by acquiring a certain number of securities in an organization or in total, or by acquiring a certain dollar amount of securities. The social network facility may enable the purchaser to make such an announcement by distributing a message to other purchasers that the purchaser has indicated the purchaser has a connection with or that have indicated a connection with the purchaser. Such a connection may include flagging another purchaser as a “friend” or “coworker” or otherwise indicating to the social network facility a relationship with the other purchaser. In some embodiments, the social network facility may enable a purchaser to query the social network to identify other purchasers who own securities related to a particular organization, such as other purchasers who own securities related to an organization for which the purchaser owns securities or is interested in owning securities.

In some embodiments, the investment system may also provide one or more entertainment features for purchasers. For example, some entertainment features may provide investment simulations for the purchasers, such as investment simulations that simulate the operations of an investment system described above. In some embodiments, an investment simulation facility may operate investment simulations based on fake purchase information that was created by a purchaser and input to the simulation. The investment simulation facility may simulate a result of an investment to determine the consequences over time, based on real market information, if the fake purchase information were real purchase information and were used as a basis for acquiring securities in the manner discussed above. Such investment simulations may simulate the status of fake investments over time, such as by monitoring securities related to the fake investments and reporting to a purchaser what would have resulted if the purchaser owned the securities. In some embodiments, the investment simulation facility may enable simulations to be performed by the investment system for any person, including persons who do not provide purchase information (as opposed to only fake purchase information) to the investment system for the acquisition of securities. In some such embodiments, enabling persons who do not provide purchase information to the investment system to interact with the investment simulations or other entertainment features of the investment systems may increase a comfort of these persons with the investment process. When their comfort with the investment process is increased, these persons may begin investing using the investment system, either through providing purchase information in the manner described above or through the brokerage facility of the investment system acting as a broker and acquiring securities on behalf of these persons.

In some embodiments, an investment system may be able to acquire securities in any commercial organization for which securities are available. In some such embodiments, all commercial organizations may be treated similarly by the investment system, as the system may carry out the same investment process regardless of the commercial organization at which a purchaser has made a purchase. In other embodiments, however, commercial organizations may be treated differently by the investment system, such as by being treated differently by the investment determination facility of the investment system. This may be because, for example, the investment system may be configured to acquire securities for only some commercial organizations, which may be less than all commercial organizations for which securities are publicly available for acquisition. As another example, some commercial organizations may be treated differently because the commercial organizations offer an additional incentive to purchasers. For example, a commercial organization may offer a purchaser an additional one percent of a purchase amount or an extra dollar toward the acquisition of securities when the purchase makes a purchase from the commercial organization. In this case, the investment determination facility may add on the additional amount when determining an amount of funds to invest and may obtain that additional amount from the commercial organization.

In some embodiments in which some commercial organizations are treated differently, the investment system may aid a purchaser in identifying commercial organizations that are treated differently. For example, the investment system may aid a purchaser in identifying commercial organizations for which the investment system can acquire securities and/or commercial organizations that offer an incentive in the purchase of securities. For example, a mapping facility of the investment system may display via an interface a map of a region and mark in the map locations of commercial organizations that are treated differently. The mapping facility may display the map via any suitable interface, including a web interface displayed on a personal computer or on a mobile device. In some embodiments, the mapping facility may display the map as one or more graphics in a web page. The map may be a map of any suitable region. In some embodiments, the mapping facility may receive or detect a location of a purchaser and display a map of a region in which the purchaser is located and mark in the map locations of commercial organizations that are treated differently. For example, the mapping facility may mark in the map of the purchaser's region locations of commercial organizations for which the investment system can purchase securities.

The investment system may maintain for each purchaser a profile including any suitable information about a purchaser or a manner in which the purchaser has configured the investment system to acquire securities on behalf of the purchaser. In some embodiments, the investment system may maintain identity information indicating an identity of a purchaser. In some jurisdictions, a service that acquires securities on behalf of a person must maintain identifying information on the person, which might be used to update public records regarding the ownership of securities. In these jurisdictions, the identifying information stored in a purchaser's profile may include at least the information that is required to be maintained by such a service. In some embodiments, the investment system may receive purchase information for a purchaser, but the security acquisition facility may refrain from acquiring securities for the purchaser until the purchaser provides identity information to the investment system.

An investment system as described herein may charge any suitable fee (including no fee) for the use of the investment system for acquisition of securities on behalf of a purchaser, as embodiments are not limited in this respect. The investment system may charge any suitable entity a fee, such as a purchaser, a financial institution, or a commercial organization. In some embodiments, the investment system may charge a fee to a commercial organization when a security related to the commercial organization is acquired on behalf of a purchaser. The investment system may charge the commercial organization the fee in these embodiments because, as mentioned above, the commercial organization may benefit from its customers owning securities related to the commercial organization. For example, the commercial organization may benefit from purchasers owning stock in the commercial organization, because the purchasers may develop a closer relationship with the commercial organization and make more purchases from the commercial organization.

In some embodiments, an investment system may maintain information on purchasers for which securities related to a commercial organization were acquired. The information on the purchasers may be, for example, information on purchases made by the purchasers or information on the purchasers themselves. Information on the purchasers may include demographic information on the purchasers and information on purchasing activity of the purchasers. Demographic information may include any suitable demographic characteristics of a purchaser, such as address information. In the case of a human purchaser, age and gender information may be included in demographic information. In the case that a purchaser is a business entity, a location of a headquarters, an industry in which the business entity operates may be included as demographic information. Information on purchasing activity may include any suitable information on purchases. For example, the investment system may maintain timing information on purchases, such as information on a frequency of purchase or patterns in purchasing (e.g., patterns in time of day or day of week of purchases).

In some embodiments in which the investment system maintains information on purchases, the investment system may generate analytics regarding purchasers. For example, an analytics facility of the investment system may analyze information on purchasers to determine patterns or trends in the information. Such analytics may relate to multiple commercial organizations from which purchasers make purchases or may relate to a single commercial organization. For example, the analytics facility may generate analytics for a single commercial organization, which may identify for the commercial organization demographic characteristics of their customers and/or purchasing habits of their customers. Because the analytics facility may generate analytics based on information regarding purchasers who have also invested in or who intend to invest in securities related to the commercial organization(s), a commercial organization may interpret the analytics on purchasers as being analytics regarding dedicated customers of the commercial organization or customers who have a strong relationship with the commercial organization. The commercial organization may therefore value analytics generated by an investment system for purchasers more than analytics generated for other customers of the commercial organization. Accordingly, in some embodiments, an analytics facility of the investment system may generate analytics for purchasers and provide the analytics to commercial organizations, and may charge a fee for providing the analytics. In some embodiments, the investment system may provide analytics generated by the analytics facility to other parties, such as market researchers or others that may have an interest in the analytics. In some embodiments, the analytics generated and provided by the investment system may not include any personally-identifiable information that may identify a purchaser, but may instead include aggregated information for multiple purchasers or information that pertains to a single purchaser but cannot personally identify the purchaser. In embodiments in which personally-identifiable information maintained by the investment system is provided to others, the investment system may obtain the explicit permission of the purchaser to provide the personally-identifiable information to others before the information is provided.

In some embodiments, the investment system may maintain, such as in a purchaser profile, contact information for purchasers identifying one or more ways to contact the purchasers. The ways to contact the purchasers may include, for example, mailing address, e-mail address, social network usernames (for one or more social networks that are a part of the investment system and/or external to the investment system), or phone numbers for purchasers. This information may be used for the investment system to contact purchasers about investments, such as securities acquired by the investment system on behalf of the purchasers. In some embodiments in which the investment system maintains contact information for the purchasers, the investment system may provide contact information for the purchasers to commercial organizations at which the purchasers made purchases or others who are interested in contacting the purchasers, such as market researchers. Providing the contact information to the commercial organizations may enable the commercial organizations to contact the purchasers, such as to thank the purchases for their patronage, to provide coupons or other discounts to purchasers, to inform the purchasers of upcoming sales or other events, or otherwise provide information regarding the commercial organization to the purchasers. In some embodiments in which the investment system provides contact information to commercial organizations, the investment system may charge a fee to commercial organizations for the contact information. In addition, in some such embodiments, the investment system may obtain the explicit permission of the purchasers to provide the contact information to the commercial organizations before the information is provided.

In addition to or as an alternative to providing the contact information to the commercial organizations or others, the investment system may receive messages from the commercial organizations or others that are to be transmitted to the purchasers. A messaging facility of the investment system, upon receiving the message, may identify purchasers to which the message is to be transmitted and transmit the message to the purchasers via mail, e-mail, phone, social network usernames, or other communication technique. The investment system may identify the purchasers in any suitable way, including based on criteria specified by the source of the message. For example, when a source of a message is a commercial organization, the commercial organization may specify that a message is to be transmitted to all purchasers who made a purchase from the commercial organization. In this example, the investment system may review information regarding purchasers, identify the purchasers who have made purchases at the commercial organization, and transmit the message to those purchasers. As another example, when a source of a message is a market researcher, the market researcher may request that a message be transmitted to purchasers matching one or more demographic and/or behavioral criteria. For example, a market researcher may request that a message be transmitted to all women over 40 who make purchases at restaurants once a week. In this example, the investment system may analyze information regarding purchasers, including analytics regarding a purchaser, identify purchasers who meet the criteria, and transmit the message to those purchasers. Any suitable criteria may be specified, as embodiments are not limited in this respect. In some embodiments that transmit messages to purchasers on behalf of commercial organizations or others, the investment system may charge for providing the message. Additionally, in some embodiments, the investment system may enable a purchaser to opt-in or opt-out to receiving messages from the investment system.

In some embodiments, the investment system may analyze purchases made by purchasers and analyze the commercial organizations at which the purchases make purchases to identify the commercial organizations that are highly commercially active. Information regarding highly commercially active that is determined by an investment system from purchase information for purchasers may be particularly valuable. As discussed above, the purchasers may be customers of commercial organizations that have strong relationships to the organizations or are otherwise motivated customers, as the purchasers have both made purchases from an organization and acquired (or intend to acquire) securities related to the organization. An identification of which commercial organizations have high commercial activity with motivated customers may be valuable, as this may identify commercial organizations that are succeeding in the marketplace.

An analytics facility of the investment system may identify the commercial organizations that are highly commercially active based on an evaluation of purchase information for one or more purchasers, including all purchasers. For example, the analytics facility may identify the organizations from which purchasers make the most number of purchases, highest dollar-value purchases in absolutes or on average, most frequent purchases, or any other suitable measurement by which purchase information may be compared. In some embodiments, the analytics facility may identify one or more sets of highly commercially active commercial organizations, which may be based on any suitable criteria. For example, the analytics facility may evaluate the purchasers in determining the commercial organizations that are highly commercially active, such as by determining commercial organizations having the highest commercial activity (measured in any suitable manner) with purchasers of one or more demographic groups, such as people aged 18-40, girls 12-21, men 18-30, or any other group. In some embodiments, the analytics facility may additionally or alternatively evaluate the commercial organizations and identify commercial organizations that are highly commercially active in particular market categories. A market category may be, for example, industry, and in these embodiments the analytics facility may identify highly commercially active commercially organizations for each of multiple industries. In this way, highly commercially active grocery stores, consumer product stores, electronic stores, or organizations in other industries may be separately identified by the analytics facility. As another example, the market category may be geographic, and the analytics facility may determine highly commercially active stores in each of multiple geographic regions. The analytics facility may identify any suitable set or sets of highly commercially active organizations based on any suitable criteria, as embodiments are not limited in this respect.

In embodiments in which commercial organizations that are highly commercially active are identified, the investment system may use a listing of such commercial organizations in any suitable manner. In some such embodiments, the investment system or an operator of the investment system may publish the listing of commercial organizations, such as via an interface (e.g., web site) of the investment system. In other embodiments, the listing of commercial organizations may additionally or alternatively be used for investing. For example, the investment system may maintain an index fund or other form of fund that owns securities related to the commercial organizations that have been identified as highly commercially active. The investment system may change the securities that are owned by the index fund over time, as an identification of companies that are highly commercially active changes over time in response to new purchase information received for purchasers. A brokerage facility of the investment system may sell shares in the fund to purchasers or others who are interested in owning shares in the fund, and may disburse at least a portion of revenue gained by the fund from selling shares and/or receiving dividends to those who own shares in the fund.

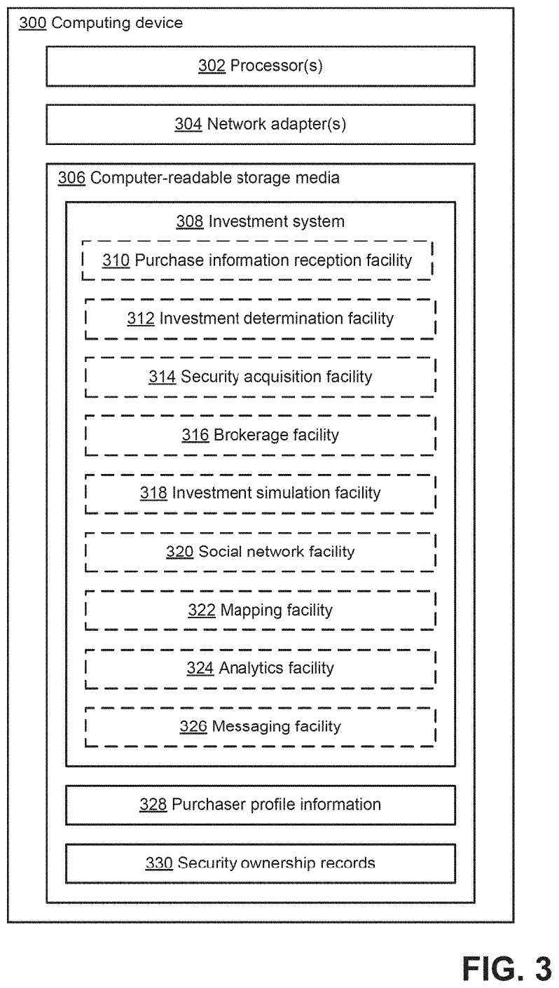

As discussed above in connection with FIG. 1, embodiments are not limited to operating with any particular computing device or type of computing device. FIG. 3 illustrates one exemplary implementation of a computing device in the form of a computing device 300 that may be used in a system implementing techniques described herein, although others are possible. It should be appreciated that FIG. 3 is intended neither to be a depiction of necessary components for a computing device to execute an interactive assignment system in accordance with the principles described herein, nor a comprehensive depiction.

Computing device 300 may comprise at least one processor 302, a network adapter 304, and computer-readable storage media 306. Computing device 300 may be, for example, a desktop or laptop personal computer, a server, a computer of a distributed computing system, or any other suitable computing device. Network adapter 304 may be any suitable hardware and/or software to enable the computing device 300 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 306 may be adapted to store data to be processed and/or instructions to be executed by processor 302. Processor 302 enables processing of data and execution of instructions. The data and instructions may be stored on the computer-readable storage media 306.

The data and instructions stored on computer-readable storage media 306 may comprise computer-executable instructions implementing techniques which operate according to the principles described herein. In the example of FIG. 3, computer-readable storage media 306 stores computer-executable instructions implementing various facilities and storing various information as described above. Computer-readable storage media 306 may store an investment system 308. As illustrated in FIG. 3, the investment system 308 may include multiple facilities to implement various functionality of the investment system 308. Exemplary operations of these facilities are discussed above. The facilities illustrated in FIG. 3 include a purchase information reception facility 310, an investment determination facility 312, a security acquisition facility 314, a brokerage facility 316, an investment simulation facility 318, a social network facility 320, a mapping facility 322, an analytics facility 324, and a messaging facility 326. In addition, computer-readable storage media 306 may store data to be used by the investment system 308, which may include purchaser profile information 328 and security ownership records 330. Purchaser profile information 328 may include information regarding one or more purchasers, including information identifying the purchasers and information identifying a manner in which the purchasers desire the investment system 308 to acquire securities on their behalf. Security ownership records 330 may include any suitable information regarding securities acquired by the investment system 308 and the purchasers on whose behalf the securities were acquired.

While not illustrated in FIG. 3, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

1.-30. (canceled)

31. A method for configuring an investment system that acquires securities on behalf of a purchaser based on purchase information describing one or more purchases made by the purchaser, the investment system comprising one or more network-connected computing devices carrying out operations of the investment system at least in part by executing executable instructions and communicating via one or more networks, the method comprising:
receiving, at the one or more network-connected computing devices, user input indicating, for a commercial organization, an amount of funds to invest in securities related to the commercial organization based on purchase information related to purchases made by the purchaser, the purchases being associated with the commercial organization; and
storing, in at least one storage medium accessible by one or more network-connected computing devices, information configuring the investment system based at least in part on the user input, the information configuring the investment system to use the amount of funds to acquire, on behalf of the purchaser, securities related to the commercial organization based on purchase information describing a purchase made by the purchaser, the purchase being associated with the commercial organization.

32. The method of claim 31, further comprising:
receiving second user input indicating, for a second commercial organization, a second amount of funds to invest in securities related to the second commercial organization based on second purchase information related to purchases made by the purchaser that are associated with the second commercial organization, the second amount of funds being different from the amount of funds,
wherein storing, in the at least one storage medium, information configuring the investment system based at least in part on the user input comprises storing information configuring the investment system based at least in part on the user input and the second user input.

33. The method of claim 31, further comprising:
receiving second user input indicating, for at least one second commercial organization, at least one second amount of funds to invest in securities related to the at least one second commercial organization based on purchase information related to purchases made by the purchaser at the at least one second commercial organization, each one of the at least one second amount of funds corresponding to one of the at least one second commercial organization;
wherein storing, in the at least one storage medium, information configuring the investment system based at least in part on the user input comprises storing information configuring the investment system based at least in part on the user input and the second user input.

34. The method of claim 33, further comprising:
receiving third user input indicating a default amount of funds to invest in securities based on third purchase information related to purchases made by the purchaser that are associated with commercial organizations different from the first commercial organization and the at least one second commercial organization;
wherein storing, in the at least one storage medium, information configuring the investment system based at least in part on the user input comprises storing information configuring the investment system based at least in part on the user input, the second user input, and the third user input to determine funds to use in acquiring securities by selecting, based at least in part on a commercial organization identified by received purchase information, an amount from among the amount of funds, the at least one second amount of funds, or the default amount of funds.

35. The method of claim 31, wherein receiving user input indicating the amount of funds comprises receiving user input comprising a percentage to be used in calculating the amount of funds, the percentage indicating a proportion of a value of funds exchanged in purchases made by the purchaser that are associated with the commercial organization, the proportion of the value of funds being the amount of funds to invest in securities.

36. The method of claim 35, wherein receiving user input indicating the amount of funds further comprises receiving user input indicating a maximum amount of funds to invest in securities based on purchase information describing a single purchase.

37. The method of claim 31, further comprising:
receiving second user input identifying a financial account of the purchaser, the financial account of the purchaser being a financial account held by a financial institution external to the investment system on behalf of the purchaser; and
storing, in the at least one storage medium, information configuring the investment system to withdraw funds from the financial account to obtain funds for investing in securities based on the purchase information.

38. The method of claim 37, wherein:
receiving the second user input identifying the financial account comprises receiving second user input identifying a bank account of the purchaser; and
storing information configuring the investment system to withdraw funds from the financial account comprises storing information configuring the investment system to transmit one or more Electronics Funds Transfer (EFT) messages to the financial institution to request transfer of funds.

39. The method of claim 31, further comprising:
receiving second user input indicating, for the commercial organization, a security related to the commercial organization to acquire on behalf of the purchaser based on the purchase information related to purchases made by the purchaser that are associated with the commercial organization; and
storing, in the at least one storage medium, information configuring the investment system to acquire the security related to the commercial organization based on the purchase information.

40. A method of operating at least one network-connected computing device, the method comprising:
operating at least one programmed processor to carry out a set of acts, the set of acts being identified by instructions with which the at least one programmed processor is programmed, the set of acts comprising:
receiving, over at least one network to which the at least one network-connected computing device is connected, purchase information describing a purchase made by a purchaser, the purchase being associated with a commercial organization;
identifying a security based at least in part on the purchase information;
obtaining funds of the purchaser to be used in investing in the security; and
using the funds, acquiring the security on behalf of the purchaser, wherein acquiring the security comprises transmitting at least one message via the at least one network.

41. The method of claim 40, wherein obtaining funds from the purchaser comprises transmitting at least one Electronic Funds Transfer (EFT) message to a financial institution with which the purchaser has a financial account.

42. The method of claim 41, wherein obtaining funds from the purchaser further comprises:
receiving funds in response to the at least one EFT message;
making a record of the funds in an account maintained for the purchaser by the investment system; and
in response to receiving the purchase information and identifying the security, withdrawing from the account maintained for the purchaser an amount of funds to be used in acquiring the security.

43. The method of claim 42, wherein receiving the funds comprises receiving the funds prior to receiving the purchase information.

44. The method of claim 41, wherein identifying the security based at least in part on the purchase information comprises reviewing profile information for the purchaser based on the commercial organization to determine a security that the investment system is to acquire based on purchases made by the purchaser from the commercial organization.

45. The method of claim 44, wherein the profile information for the purchaser comprises information regarding a plurality of commercial organizations, the information regarding the plurality of commercial organizations comprising, for the commercial organization, an identification of a security that the purchaser desires to acquire based on purchases made by the purchaser from the commercial organization, the security being related to the commercial organization.

46. The method of claim 40, further comprising:
identifying an amount of funds to use in acquiring securities based on the purchase information, wherein identifying the amount of funds comprises reviewing profile information for the purchaser based on the commercial organization to determine an amount of funds that the investment system is to use in acquiring securities based on purchases made by the purchaser from the commercial organization.

47. The method of claim 46, wherein the profile information for the purchaser comprises information regarding a plurality of commercial organizations, the information regarding the plurality of commercial organizations comprising, for the commercial organization, an amount of funds that the purchaser desires to use in acquiring securities based on purchases made by the purchaser from the commercial organization.

48. The method of claim 47, wherein the information regarding the plurality of commercial organizations comprises, for a second commercial organization, a second amount of funds that the purchaser desires to use in acquiring securities based on purchases made by the purchaser from the second commercial organization.

49. The method of claim 40, wherein acquiring the security on behalf of the purchaser comprises one or more of: updating public ownership records regarding the security to reflect ownership of the security by the purchaser, communicating with a brokerage service, executed by at least one computing device, to update public ownership records regarding the security to reflect ownership of the security by the purchaser, communicating with a brokerage service, executed by at least one computing device, to request that the brokerage service acquire the security, storing, in a data store of the investment system, information indicating ownership of the security by the purchaser, and acquiring a fraction of the security on behalf of the purchaser.

50. A method of operating at least one network-connected computing device, the method comprising:
operating at least one programmed processor to carry out a set of acts, the set of acts being identified by instructions with which the at least one programmed processor is programmed, the set of acts comprising:
receiving, over at least one network to which the at least one network-connected computing device is connected, information describing a commercial activity in which a person engaged, the commercial activity being associated with a commercial organization;
identifying a security based at least in part on the information describing the commercial activity;
obtaining funds of the purchaser to be used in investing in the security; and
using the funds, acquiring the security on behalf of the purchaser, wherein acquiring the security comprises transmitting at least one message via the at least one network.
